(19) United States
(12) Patent Application Publication
(10) Pub. No.: US 2004/0114044 A1
(43) Pub. Date: Jun. 17, 2004

(54) Digital camera with keyboard and wireless modem

(75) Inventors: Kevin B. McCurdy, Menlo Park, CA (US); Andrew H. Mutz, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mamoto Corporation, Palo Alto, CA

(21) Appl. No.: 10/320,891

(22) Filed: Dec. 16, 2002

(51) Int. Cl. H04N 5/262

(52) U.S. Cl. 348/207.99; 348/239

(57) ABSTRACT

A digital camera is equipped with a wireless modem, a keyboard, a display screen and a screen navigation element. The modem provides for transfer of digital images over a wireless network infrastructure, while the keyboard and screen navigation element provide for efficient selection of functions, including camera functions and transmission of images, and for text entry and remote file management. The camera according to the invention is provided with an identification mechanism at the MAC layer which allows it to be uniquely identified within a network. The camera is capable of performing a variety of functions in connection with a compatible infrastructure, such as a central image storage facility.

### CROSS-REFERENCES TO RELATED APPLICATIONS

Not application

### STATEMENT AS TO RIGHTS TO INVENTIONS MADE UNDER FEDERALLY SPONSORED RESEARCH OR DEVELOPMENT

Not application

### REFERENCE TO A “SEQUENCE LISTING,” A TABLE, OR A COMPUTER PROGRAM LISTING APPENDIX SUBMITTED ON A COMPACT DISK.

Not application

### BACKGROUND OF THE INVENTION

This invention relates to digital photography and in particular to the enhancement of control, transfer and management of digital photographs.

Digital cameras employ a photosensitive electronic array formed by a charge-coupled device or CMOS photosensor array aligned behind a lens and shutter mechanism. The typical digital camera is controlled by a processor which manages camera functions which include at least some of focus, flash, exposure, lens aperture, and the collection and encoding of data from the light sensor array.

Several existing implementations of cameras with character-selection mechanisms are known in the literature. In U.S. Pat. No. 6,167,469, Safai of Agilent Technologies describes an electronic digital camera which displays on its image display screen a graphical representation of a keyboard, from which characters may be selected. In one implementation, a touch-screen is described. The described virtual keyboard requires close attention to entry to assure accurate selection of functions. In addition, cameras are known with pressure sensitive membrane touchpads on which dedicated function keys are depicted, the function key sets being of relatively limited functionality.

A wireless camera was contemplated by Parulski et.al. in U.S. Pat. No. 5,666,159 assigned to Kodak. In this patent, Parulski describes a camera with a cellular radio capable of communicating with preselected fixed base stations. The patent failed to disclose or suggest Moreover, this device contemplated using a cellular modem with sporadic connectivity. It is believed that this product model has been discontinued without a replacement.

Cellular telephones are known with text message capability and with small ancillary digital cameras. These cameras are currently popular among consumers in Asia. The telephone-based keyboards lack full functionality, often requiring multiple serial strokes per alphabetic memory, limiting functionality and flexibility.

Other patents of interest, including those aforementioned include:

U.S. Pat. No. 4,897,732 Electronic camera owned by Canon Kabushiki Kaisha

U.S. Pat. No. 4,939,767 System and method for transmitting image data on a telephone network or equivalent owned by Sanyo Electric Co., Ltd. (Osaka, JP)

U.S. Pat. No. 5,153,582 Method of and apparatus for acknowledging and answering a paging signal owned by Motorola, Inc. (Schaumburg, Ill.)

U.S. Pat. No. 5,164,831 Electronic still camera providing multi-format storage of full and reduced resolution images owned by Eastman Kodak Company (Rochester, N.Y.)

U.S. Pat. No. 5,220,366 Message receiving data back for camera, owned by Camera World, Inc. (Charlotte, N.C.)

U.S. Pat. No. 5,264,935 System for wireless transmission and reception of a video signal and corresponding audio signal owned by Sony Corporation (Tokyo, JP)

U.S. Pat. No. 5,381,412 Multimedia communication apparatus owned by Canon KK (Tokyo, JP)

U.S. Pat. No. 5,402,170 Hand-manipulated electronic camera tethered to a personal computer owned by Eastman Kodak Company (Rochester, N.Y.)

U.S. Pat. No. 5,440,699 System by which a remote computer receives screen images from and transmits commands to a host computer owned formerly by Compaq Computer Corporation (Houston, Tex.)

U.S. Pat. No. 5,550,646 Image communication system and method owned by Lucent Technologies Inc. (Murray Hill, N.J.)

U.S. Pat. No. 5,579,239 Remote video transmission system of Freeman, Michael C.

U.S. Pat. No. 5,636,211 Universal multimedia access device owned by Motorola, Inc. (Schaumburg, Ill.)

U.S. Pat. No. 5,640,195 Multimedia communication system, multimedia information transmitting apparatus and multimedia information receiving apparatus owned by Canon KK (Tokyo, JP)

U.S. Pat. No. 5,666,159 Electronic camera system with progranmable transmission capability owned by Eastman Kodak Company (Rochester, N.Y.)

U.S. Pat. No. 5,717,496 Electronic imaging apparatus owned by Olympus Optical Co., Ltd. (Tokyo, JP)

U.S. Pat. No. 5,737,491 Electronic imaging system capable of image capture, local wireless transmission and voice recognition owned by Eastman Kodak Company (Rochester, N.Y.)

U.S. Pat. No. 5,806,005 Wireless image transfer from a digital still video camera to a networked computer owned by Ricoh Corporation (U.S. headquarters Menlo Park, Calif.)

U.S. Pat. No. 5,815,201 Method and system for reading and assembling audio and image information for transfer out of a digital camera owned by Ricoh Company, Ltd. (Tokyo, JP)

U.S. Pat. No. 5,914,787 Electronic imaging apparatus by Olympus Optical Co., Ltd. (Tokyo, JP)

U.S. Pat. No. 5,943,603 Electronic camera system with programmable transmission capability owned by Eastman Kodak Company (Rochester, N.Y.)

U.S. Pat. No. 5,964,833 Pager enhanced keyboard and system owned by Datalink Systems Corp. (San Jose, Calif.)

U.S. Pat. No. 6,018,774 Method and system for creating messages including image information owned by YoBaby Productions, LLC (Cambridge, Mass.)

U.S. Pat. No. 6,161,131 Digital real time postcards including information such as geographic location or landmark (Jeffrey Garfinkle)

U.S. Pat. No. 6,167,469 Digital camera having display device for displaying graphical representation of user input and method for transporting the selected digital images thereof owned by Agilent Technologies, Inc. (Palo Alto, Calif.)

U.S. Pat. No. 6,278,442 Hand-held electronic device with a keyboard optimized for use with the thumbs owned by Research In Motion Limited (Waterloo, Canada)

U.S. Pat. No. 6,285,471 Telecommunications system for transmitting images owned by Siemens Aktiengesellschaft (Munich, Del.).

To summarize, a wide variety of variations of camera, PDA, keyboard, and wireless communications devices have been invented. None of the prior art has enabled the straightforward and simple capture of high quality photographs, the rapid and efficient selection and annotation of such images, and the seamless and continually available wireless communication of such images to a selected end-user in a single integrated device. There remains a need for quality imaging, rapid and efficient text entry and efficient management and transmission of images.

### SUMMARY OF THE INVENTION

According to the invention, a digital camera is equipped with a wireless modem, a QWERTY keyboard with tactile feedback, a display screen, a screen navigation element and a mechanism to store and process customizable presentation forms. The modem provides for transfer of digital images over a wireless network infrastructure, while the keyboard and screen navigation element provide for efficient selection of functions, including camera functions and transmission of images, and for text entry and remote file management. The camera according to the invention is provided with an identification mechanism at the MAC layer which allows it to be uniquely identified within a network to a gateway server which provides additional camera-specific services. The camera is capable of performing a variety of functions in connection with a compatible infrastructure, such as a central image storage facility.

The tactile feedback QWERTY keyboard incorporated into the digital camera provides a substantial improvement in functional convenience. The tactile keyboard provides substantial speedup in operation by elimination of manual input augmentation devices, such as a stylus, and the required display of user interface is minimized. The camera is also capable of communicating complex textual information and management of remote databases of image files using persistent forms stored in the camera.

The keyboard and the navigation device are small enough to fit conveniently within the form factor of a digital electronic camera. The formerly tedious task of selecting text characters to send an email or to annotate a file without such a keyboard hereafter becomes efficient, with data entry speeds approaching 25 words per minute, or about 40% of the maximum speed of a user with a full-sized keyboard. The keyboard according to the invention saves room on the display previously devoted to navigation or character selection icons, such as those found on a graphical or “soft” keyboard. The use of the full function QWERTY keyboard enables rapid selection of commonly used camera functions via shortcut keys which utilize the shift-key in combination with another keyboard key, such as ALT-F for flash, for instance, or ALT-A for attaching an image to a message. Additionally, navigation between camera functions using icons is extremely rapid and natural using the screen navigation device. The screen navigation device is typically a small rotating wheel which is rotated to move between selections and depressed to perform selection. There may be a mechanism for selecting, previewing, and annotating images from the camera for the purpose of sending them to a recipient via email. Further there may be a mechanism for selecting images for printing via an online photo printing service. Still further there may be a mechanism for providing forms on the display that can be completed for the purpose of linking images into enterprise applications such as insurance claims processing. An alternative embodiment is an apparatus for interfacing to a digital camera through an appropriate control interface port, such as a serial port, a USB port, an IEEE 1394 port or a Bluetooth interface, which provide the functionality of the present invention.

The invention will be better understood by reference to the following detailed description in connection with the accompanying drawings.

### BRIEF DESCRIPTION OF THE DRAWINGS

FIG. 1 is a block diagram of a camera system according to the invention.

FIG. 2A is a simple illustration of the rear of a camera unit in accordance with the invention.

FIG. 2B is a simple illustration of the front of a camera unit in accordance with the invention.

FIG. 3 is a block diagram of a camera system including a gateway server according to the invention.

FIGS. 4A and 4B together form a flow chart of selected functions of the camera system according to the invention.

FIG. 4C is a flow chart of selected functions of the service system associated with the camera according to the invention.

### DESCRIPTION OF SPECIFIC EMBODIMENTS OF THE INVENTION

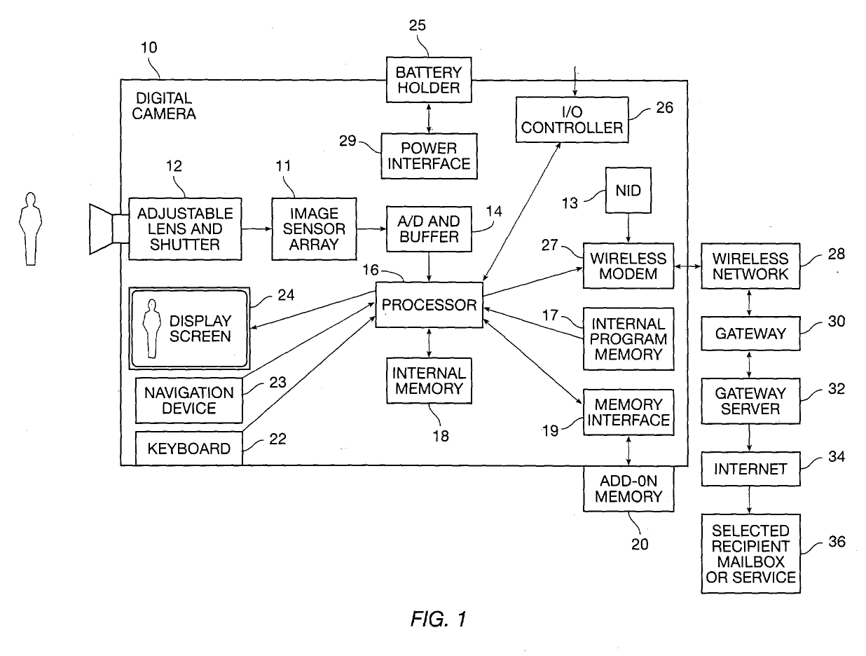

Referring to FIG. 1, there is shown a block diagram of a digital camera 10 according to the invention having integrated together an input/output controller (including manual controls and external bus connection) 26, adjustable zoom lens and shutter mechanism 12, an image sensor array 11 coupled to an A/D and buffer 14 as an image file capture mechanism, a processor 16 which manages camera system functions that include at least some of focus, flash, exposure, lens aperture, zoom and the collection and encoding of data from the image sensor array 11 under control of internal program memory (EPROM) 17, internal rewritable memory 18, a memory interface mechanism 19 to accept an add-on memory device 20, a full function keyboard 22, a display screen 24, a navigation device 23, a power interface 29, a battery compartment 25, and a wireless modem 27. The memory devices 18, 20 may be nonvolatile memory elements, such as flash memory or magnetic memory disk, and there may be a certain amount of high speed Random Access Memory.

According to the invention, the camera 10 is equipped with a full function keyboard 22, full camera functions and a wireless modem 26 and is operative to communicate with a wireless network 28, such as a packet-switched network or circuit-switched network as hereinafter explained. Suitable networks may operate according to any one of the following protocols: GSM, GSM/GPRS, CDMA, CMDA2000, CDMA 1×, 802.11a, 802.11b, 802.11g, TDMA, Ricochet, AMPS, Mobitex, Datatac, WCDMA, GMRS, amateur radio, 3G, 4G, UWB, UMTS, ISM, and satellite relay, the descriptions of which are beyond the scope of this invention. The camera 10 according to the invention has the ability to detect an access element in a wireless network 28 and use such a network 28 to connect to the Internet when such an access element is available.

The modem 26 is capable of transferring image data of the camera 10 to a selected recipient mailbox or service 36 using an intermediate server gateway 30 and gateway server 32 over the Internet 34. To enable this user functionality according to the invention, there are provided keyboard 22 has tactile feedback and the navigation device 23 (typically a thumbwheel, back button and options button) enables a user to view and select features rapidly, view and select and enter email addresses quickly, readily enter text for email messages to annotate images, and attach images to email messages.

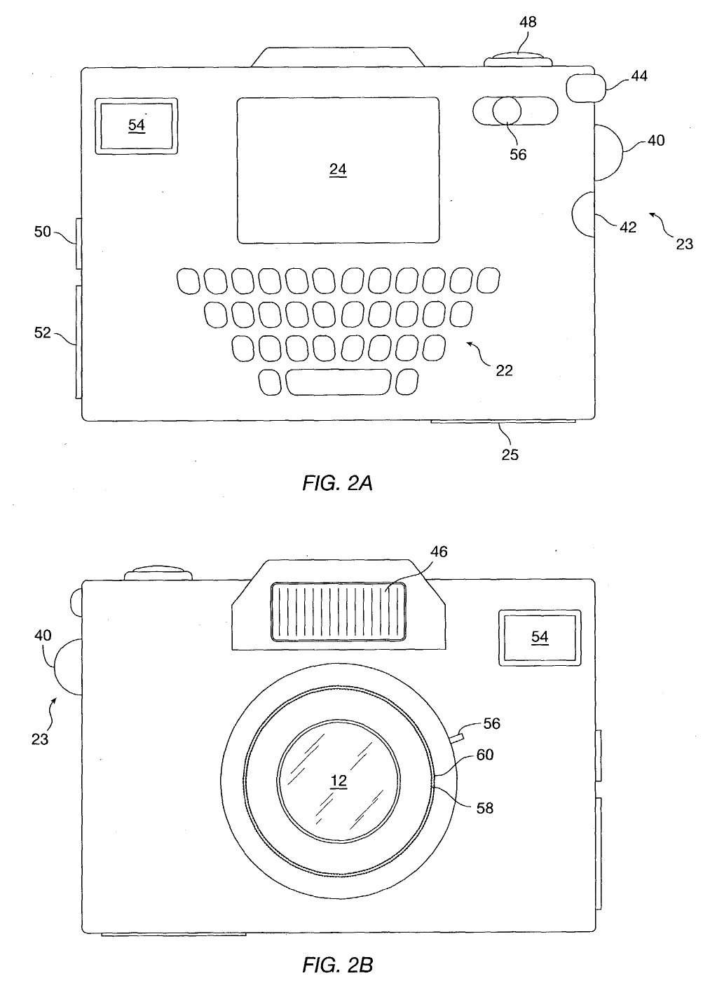

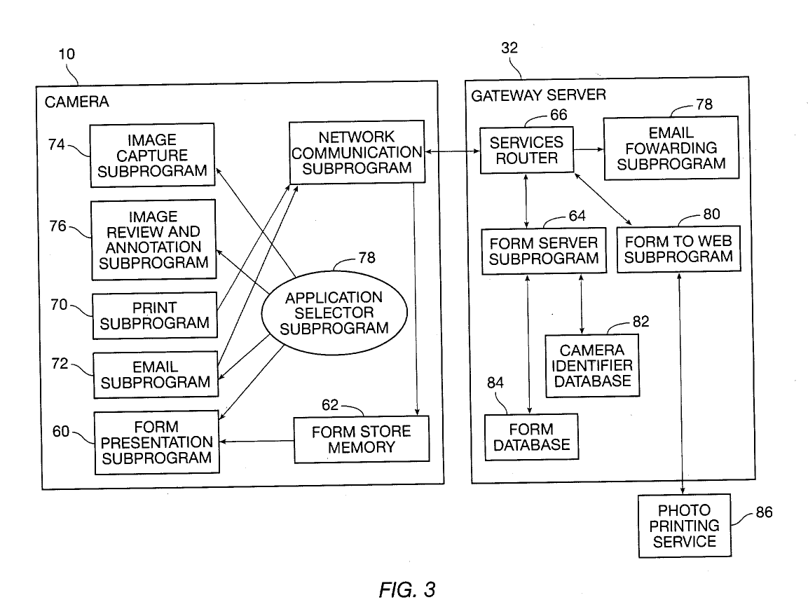

Referring to FIG. 2B, importantly, the tactile keyboard 22 and additional navigation device 23 are together small enough to fit conveniently within the form factor of the digital electronic camera 10 according to the invention, and to render the formerly tedious task of selecting text characters without a “full function” keyboard extremely efficient, with data entry speeds approaching 25 words per minute, or about 40% of the maximum speed of a user with a full-sized QWERTY-style keyboard. The tactile keyboard 22 saves room on the display 24 previously devoted to navigation or character selection icons. The use of the keyboard 22 enables rapid selection of commonly used camera functions via shortcut keys which utilize the shift-key in combination with another keyboard key, such as ALT-F for flash or ALT-A for attaching an image to a message. Additionally, navigation between camera functions using icons is extremely rapid and natural using the screen navigation device 23. The screen navigation device 23 includes a small rotating wheel 40 which is rotated to move between selections and depressed to perform selection functions. It also includes a back button 42 for returning to an immediately previous state, and a menu button 44 for changing the display screen 24 to a menu mode for overlaying menu options on a current view on the display screen 24. Referring to FIG. 2B and 2A, also included are a flash mechanism 46, a lens with shutter 12, shutter release 48, USB connector 50, memory card slot 52, optional viewfinder 54, optional focal length adjustment 56, optional aperture adjustment 58 and focus adjustment 60.

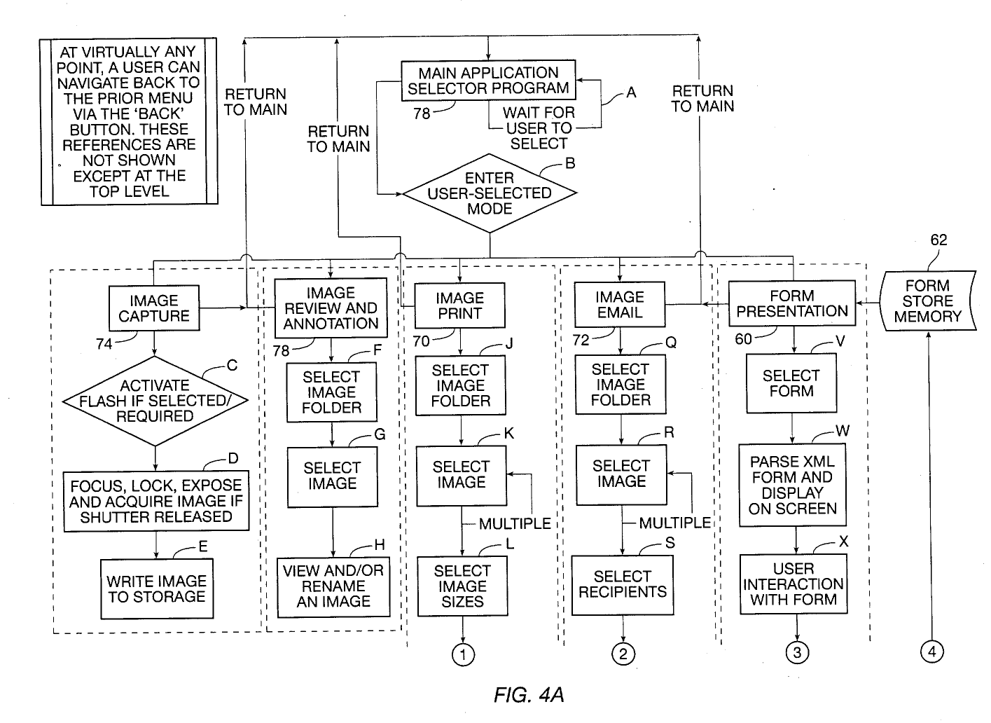

Referring to FIG. 3, there is a high-level flow chart illustrating selected functions of the camera 10 according to the invention in conjunction with support infrastructure according to the invention. According to the invention, the camera 10 employs the conventional XML specification for display presentation markup to describe selected persistent forms stored in the camera. To this end, the camera 10 employs within itself a form presentation subprogram 60 for image and data presentation using a combination of an XML parser (a program element not shown) and a predefined style format (optionally) stored within a form store memory 62. The forms are received from the remote gateway server 32 having a form server subprogram 64 via the services router 66 in communication with the camera via the wireless to wired gateway 30. In the camera 10 is a communication subprogram 68 for this purpose. The camera 10 employs the network communication subprogram 68 in a layer underlying selected applications, including the form presentation subprogram 60, as well as a print subprogram 70, and an email subprogram 72. An image capture subprogram 74 is also employed in the camera 10 along with an image review and annotation subprogram 76. All of the camera-resident function-specific subprograms are accessible via an application selector subprogram 78.

The gateway server 32 according to the invention represents the remote infrastructure which interfaces with the camera 10. The services router 66 directs communication, including outgoing email through an email forwarding subprogram 79 (primarily to support outbound image and email transmission from the camera 10), the form server subprogram 64, and a specialized-function form to web subprogram 80. The form server subprogram 64 uses a camera identifier database 82 to correlate forms in the form database 84 to the specific camera 10. The form to web subprogram 80 passes data and images between the camera 10 and a photo printing/hosting service 86. Examples of known commercial photo printing/hosting services are Shutterfly (http://www.shutterfly.com) and Ofoto (http://www.ofoto.com). Thus the purpose of the gateway server 32 according to the invention is to provide the technical and commercial interface between individual digital communication cameras 10 according to the invention and photo printing and hosting services. The camera user therefore has convenient access to services without reliance on auxiliary communications and computing devices.

While there may be inventive aspects in the specific implementations of this type of infrastructure, there are a variety of options for implementation which are within the capabilities of those of ordinary skill in the art of client-server programming. Therefore, specific examples are not disclosed herein, since they are beyond the scope of this patent application.

Referring again to FIG. 1, the camera 10 is provided with a unique physical identification mechanism bound to the hardware, for example in the Media Access Control (MAC) layer of the telecommunication protocol on the wireless network 28. This network identifier (NID) 13 may be supplied by the manufacturer or appended to the camera control software or firmware by the network provider. Where the camera and the modem are inseparable, the NID 13 is shared among all subsystems, namely camera, modem and keyboard. In an alternative embodiment, a small memory element such as a SIM or memory card may be supplied to the camera to add a NID 13 so that the system is uniquely identified to the network.

In operation, the gateway server 32 or an application accessed via the gateway server uses the NID 13 to identify the camera 10 for the purpose of adapting and customizing the user-specific applications and other content of the camera 10 and to enable services 36 to which the camera 10 has been granted authorization. A username and password may still be required to access services associated with the camera system.

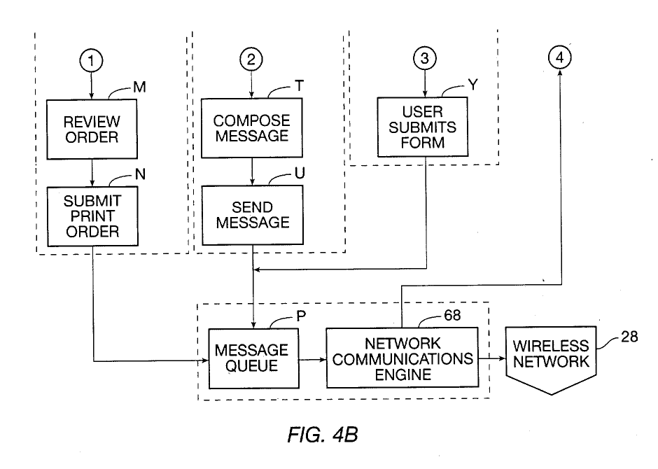

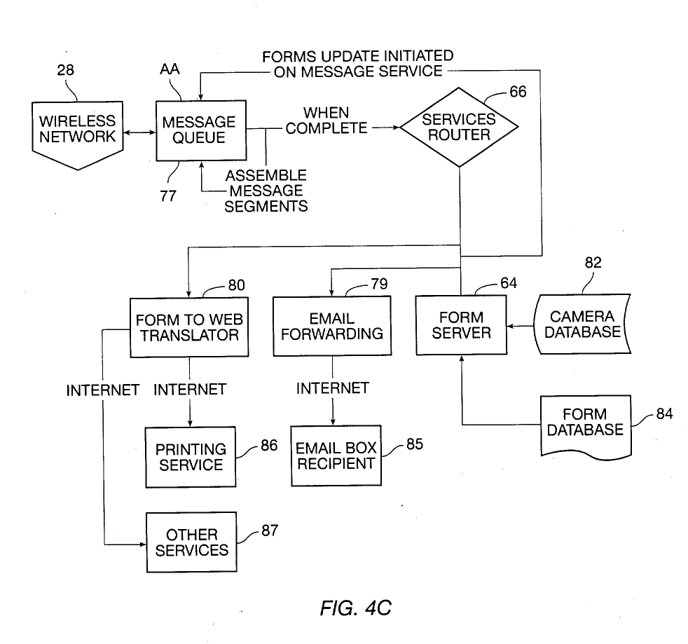

Referring to FIGS. 4A and 4B, there is a flow chart of operations of the integrated functions of the camera. Interface is through the main application selector program 78, which is in a data receiving state awaiting user input (Step A). Upon receipt of a user input of selected mode (Step B), it enters one of five modes: form presentation 60, image print 70, image email 72, image capture 74, or image review and annotation 76. Under image capture 74, the flash is activated upon request (Step C) and upon shutter release, the combined steps of focus, lock, expose and acquire are effected (Step D), and the image is written and stored (Step E).

Under image review and annotation 76, an image folder or directory is selected (Step F), an image is selected (Step G) and then viewed and/or renamed (Step H).

Under image print 70, an image folder or directory is selected (Step J), one or more image are selected (Step K), sized (Step L), presented for review by the user (Step M), and then a print order is submitted for execution (Step N). It goes into a message queue (Step P) which is routed to the network communication engine 68 and onto the wireless network 28 for transmission and eventual processing.

Under image email 72, an image folder or directory is selected (Step Q), one or more images are selected (Step R), recipients are selected (Step S), a message is composed on the full function keyboard of the camera (Step T), and the command is given to send the message (Step U), whereupon the message is queued (Step P) as before.

Under form presentation 60, a form is selected from the form store memory (Step V), and then the form is parsed into XML form and displayed on the camera screen (Step W) to permit user interaction with the form via the full function keyboard (Step X). the user then submits the form to the message queue (Step Y), which passes it on to the network communication engine 68 as before. The engine 68 may provide feedback to the form store memory 62 which then becomes available to the form presentation program for subsequent selection.

At the services or processing end of the wireless network 28 (FIG. 4C), incoming messages are passed to the message queue 77 and if necessary assembled from constituent parts, then directed to the services router 66 to update forms and to respond to the request for services, which include the form to web translator 80, email forwarding 79, or to the form server 64 for centralized storage. It may also receive information from the form database 84 and the camera database 82.

The email forwarding service routes to an email recipient mailbox 85 via the Internet. The translator 80 directs images to the printing service 86 or to other services 87 via the Internet.

The invention has been described with respect to specific embodiments. Other embodiments will be evident to those of ordinary skill in the art. Therefore, the invention should not be limited, except as indicated by the appended claims.

What is claimed is:

1. A camera comprising:
a digital camera system, including a processor means, a display screen, and internal digital storage for capturing, storing and displaying digital images;
a digital wireless r.f. modem for transmitting digital images and data extracted from input to presentation forms via a wireless gateway to a network; and
control input means integrated into said digital camera system and said wireless modem, said control input means including a full-function QWERTY keyboard with tactile feedback for entry of camera control and modem control functions, for interacting with customizable presentation forms stored in said camera, and for entry of textual information.

2. The camera according to claim 1 wherein said full-function alpha-numeric keyboard includes at least one function key preprogrammed in connection with selected alpha-numeric keys for shortcut entry of selected primary camera functions.

3. The camera according to claim 1 wherein said full-function alpha-numeric keyboard includes at least one function key preprogrammed in connection with selected alpha-numeric keys for shortcut entry of selected modem transmission functions.

4. The camera according to claim 1 wherein said full-function alpha-numeric keyboard includes at least one function key preprogrammed in connection with selected alpha-numeric keys for shortcut entry of selected functions.

5. The camera according to claim 1 wherein said control input means further includes a display navigation element for navigating among displayed information on said display screen and for selecting functions represented by said displayed information.

6. The camera according to claim 5 wherein said display navigation element comprises a wheel switch.

7. The camera according to claim 6 wherein said control input means further includes a back button proximate to said wheel switch.

8. The camera according to claim 1 wherein said control input means further includes a back button.

9. The camera according to claim 1 wherein said processor means, said storage, and said modem means are further operative to capture, store and respond to images and actionable data files via said gateway.

10. The camera according to claim 9 wherein said actionable data files are forms of XML format.

11. The camera according to claim 1 wherein said modem comprises a wide area wireless radio frequency modem selected from a group of modes consisting of:
GSM, GSM/GPRS, CDMA, CMDA2000 , 802.11a, 802.11b, 802.11g, TDMA, Ricochet, AMPS, Mobitex, Datatac, WCDMA, GMRS, amateur radio, 3G, 4G, UWB, UMTS, satellite relay and ISM.

12. A digital camera system comprising:
a camera unit having integrated therein a processor means, a display screen for displaying digital images, internal digital storage for capturing and storing digital images, control input means including a full-function alpha-numeric keyboard with tactile feedback for entry of control functions and for entry of textual information, and a digital wireless r.f modem for transmitting digital images via a wireless gateway; and
a gateway server coupled via the wireless gateway to said camera unit, said gateway server having email forwarding means, a form server and a web service interface for providing specified forms to said camera unit and for communicating images and messages from said camera unit to email services via said email forwarding means and to a photograph printing/hosting service via said web service interface.

13. The digital camera system according to claim 12 wherein said gateway server further includes:
a camera identifier database for logically connecting said camera unit with a profile; and
a form database for supplying camera-specific persistent actionable data files to said camera unit.

14. The digital camera system according to claim 12 wherein said gateway server further includes:
a services router for selecting among said email forwarding means, said form server and said web services interface.

15. The camera system according to claim 12 wherein said modem comprises a wide area wireless radio frequency modem selected from a group of modes consisting of:
GSM, GSM/GPRS, CDMA, CMDA 2000, 802.11a, 802.11b, 802.11g, TDMA, Ricochet, AMPS, Mobitex, Datatac, WCDMA, GMRS, amateur radio, 3G, 4G, UWB, UMTS, satellite relay and ISM.
